(19) United States
(12) Patent Application Publication
(10) Pub. No.: US 2006/0074875 A1
(43) Pub. Date: Apr. 6, 2006

(54) Method and apparatus for predicting relative selectivity of database query conditions using respective cardinalities associated with different subsets of database records

(75) Inventors: Michael S. Faunce, Rochester, MN (US); Wayne Christopher Sadecki, Rochester, MN (US)

Correspondence Address: Steven W. Roth;IBM Corporation, Dept. 917, 3605 Highway 52 North, Rochester, MN, 55901-7829, US

(73) Assignee: International Business Machines Corporation, Armonk, NY (US)

(21) Appl. No.: 10/955,742

(22) Filed: Sep. 30, 2004

(51) Int. Cl. G06F 17/30

(52) U.S. Cl. 707/3

(57) ABSTRACT

A database management system associates, for one or more database fields, a respective representation of cardinality with different discrete subsets of database records, the subsets preferably being defined by different quantiles of an equal height histogram. The system predicts a relative number of records responsive to a query condition using the representation of cardinality of a quantile in which a query-specified value lies. Preferably, a relative number of responsive records is estimated as a quantile size representation divided by a cardinality representation. The system uses this prediction to determine an optimum query execution strategy. Preferably, the system derives histogram data including cardinality and ordinal numbers corresponding to each quantile using sampling techniques.

### FIELD OF THE INVENTION

The present invention relates generally to digital data processing, and more particularly to the generation and execution of database queries in a digital computer system.

### BACKGROUND OF THE INVENTION

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users.

A modern computer system typically comprises hardware in the form of one or more central processing units (CPU) for processing instructions, memory for storing instructions and other data, and other supporting hardware necessary to transfer information, communicate with the external world, and so forth. From the standpoint of the computer's hardware, most systems operate in fundamentally the same manner. Processors are capable of performing a limited set of very simple operations, such as arithmetic, logical comparisons, and movement of data from one location to another. But each operation is performed very quickly. Programs which direct a computer to perform massive numbers of these simple operations give the illusion that the computer is doing something sophisticated. What is perceived by the user as a new or improved capability of a computer system is made possible by performing essentially the same set of very simple operations, but doing it much faster. Therefore continuing improvements to computer systems require that these systems be made ever faster.

The overall speed at which a computer system performs day-to-day tasks (also called “throughput”) can be increased by making various improvements to the computer's hardware design, which in one way or another increase the average number of simple operations performed per unit of time. The overall speed of the system can also be increased by making algorithmic improvements to the system design, and particularly, to the design of software executing on the system. Unlike most hardware improvements, many algorithmic improvements to software increase the throughput not by increasing the average number of operations executed per unit time, but by reducing the total number of operations which must be executed to perform a given task.

Complex systems may be used to support a variety of applications, but one common use is the maintenance of large databases, from which information may be obtained. Large databases usually support some form of database query for obtaining information which is extracted from selected database fields and records. Such queries can consume significant system resources, particularly processor resources, and the speed at which queries are performed can have a substantial influence on the overall system throughput.

Conceptually, a database may be viewed as one or more tables of information, each table having a large number of entries (analogous to row of a table), each entry having multiple respective data fields (analogous to columns of the table). The function of a database query is to find all rows, for which the data in the columns of the row matches some set of parameters defined by the query. A query may be as simple as matching a single column field to a specified value, but is often far more complex, involving multiple field values and logical conditions.

Execution of a query involves retrieving and examining records in the database according to some strategy. For any given logical query, not all query execution strategies are equal. Various factors may affect the choice of optimum query execution strategy. In particular, where a logical AND (or logical OR) of multiple conditions is specified, the sequential order in which the conditions are evaluated can make a significant difference in the time required to execute the query. The sequential order of evaluation is significant because the first evaluated condition is evaluated with respect to all the records in a database table, but a later evaluated condition need only be evaluated with respect to the subset of records for which the first condition was true. Similarly, for a query involving multiple conditions conjoined by a logical OR, a later evaluated condition need only be evaluated with respect to the subset of records for which an earlier condition was false. Therefore, as a general rule, it is desirable to evaluate those conditions which are most selective (i.e., eliminate the largest number of records from consideration) first, and to evaluate conditions which are less selective later. Other factors, such as the availability of database indexes or the relative difficulty of evaluating various conditions, may also affect the choice of optimum execution strategy.

To support database queries, large databases typically include a query engine and/or query optimizer, which executes the queries according to some automatically determined query execution strategy, using the known characteristics of the database and other factors. For the reasons explained above, in order to determine an optimum execution strategy, it is desirable to know in advance the number of records selected by each condition. Unfortunately, this is generally impossible to determine precisely in advance, without actually evaluating the conditions (i.e., without performing the query). There are, however, certain techniques whereby a query engine or optimizer may estimate the number of responsive records without actually performing the query.

One technique for estimating the selectivity of a query condition involves the use of “equal height histograms”. An “equal height histogram” is a data structure which allocates the database records to multiple “quantiles”, according to the value of an ordered data field (“column”) within the database table, each quantile having an approximately equal number of records. The equal height histogram data structure typically records the column values at the boundaries of each quantile, it being possible to quickly determine the quantile into which any particular record falls from the ordering relation of the column value.

Using an equal height histogram, the query engine or optimizer can rapidly estimate the number of records responsive to a query condition specifying a range of values for the column by determining the number of quantiles spanned by the range, interpolating the number of records for any partial quantiles. This technique works reasonably well where a range of values spanning several quantiles is specified. However, where query condition specifies a portion of a quantile, such as records equal to a particular value, the equal height histogram provides limited information. It is possible to determine the quantile in which the specified value lies, and therefore determine the maximum number of possible responsive records, but the actual number of records could be far less.

In order to predict the number of records responsive to a query condition specifying a particular value, some databases further record, for each desired column, the overall cardinality of the database column, i.e., the number of discrete values in the column. If it is assumed that the values are distributed equally over the database records, then for any query condition specifying a particular value, the predicted number of responsive records is the quotient of the total number of records in the database and the cardinality of the column in which the value is specified. Unfortunately, there are many instances in which values of a particular data field are not equally distributed. In these instances, the above technique produces relatively poor predictions of the number of responsive records.

In order to improve the optimization of database queries, it would be desirable to provide more accurate predictions of the number of records responsive to a database query condition, and in particularly, responsive to a query condition specifying a particular value in a data field.

### SUMMARY OF THE INVENTION

A database management system associates, for one or more database fields, a respective representation of cardinality with different discrete subsets of database records. Preferably, these discrete subsets are defined by the different quantiles of an equal height histogram, the respective representation of cardinality being associated with each quantile of the equal height histogram. The database management system predicts a relative selectivity of a query condition, i.e. a relative number of records responsive to a condition in a query, using the representation of cardinality of a quantile in which a query-specified value lies.

In an exemplary embodiment described herein, a database query contains multiple conditions, at least one of the conditions specifying that a particular data field be equal to some discrete value. The database management system accesses the equal height histogram for the particular data field, and determines the quantile in which the discrete value specified by the query lies. A cardinality and ordinal number are associated with the quantile in the equal height histogram. The system predicts the relative number of records responsive to the query condition as the average number of records per discrete value within the quantile, i.e., as the size of the quantile (indicated by the ordinal number) divided by the cardinality of the quantile. The query engine (or optimizer) uses this prediction to determine an optimum query execution strategy.

In the preferred embodiment the histogram stores representations of the cardinality and ordinal number position corresponding to each quantile, these values being derived by sampling techniques using a limited size sample. The cardinality and ordinal number values thus derived are intended as relative representations to be used for comparative purposes, not as estimates of the actual count of number of discrete values or number of records within a quantile.

By associating a separate cardinality with each quantile of an equal height histogram, it is possible to more accurately compare the predicted numbers of records responsive to different database query conditions, particularly conditions which reference a subset of a given quantile, an example of which is a condition specifying equality to fixed, discrete value. Moreover, this prediction can be accomplished rapidly, without significant additional overhead. Increased prediction accuracy improves the choice of optimum execution strategy, thus improving the utilization and performance of system resources in response to database queries.

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level block diagram of the major hardware components of a computer system for determining query execution strategies and executing queries, according to the preferred embodiment of the present invention.

FIG. 2 is a conceptual illustration of the major software components of a computer system of FIG. 1, according to the preferred embodiment.

FIG. 3 is a conceptual representation of the structure of a database and associated equal-height histogram data structures, according to the preferred embodiment.

FIG. 4 is an example of a portion of a database illustrating the application of the technique for predicting the selectivity of a query condition, according to the preferred embodiment.

FIG. 5 is a flow diagram illustrating at a high level the process of executing a database query, according to the preferred embodiment

FIG. 6 is a flow diagram showing in greater detail the process of estimating the selectivity of a query condition within the process of FIG. 5, according to the preferred embodiment.

FIG. 7 is a high-level flow diagram representing a process for generating sampled histogram records, according to the preferred embodiment.

### DETAILED DESCRIPTION OF THE PREFERRED EMBODIMENTS

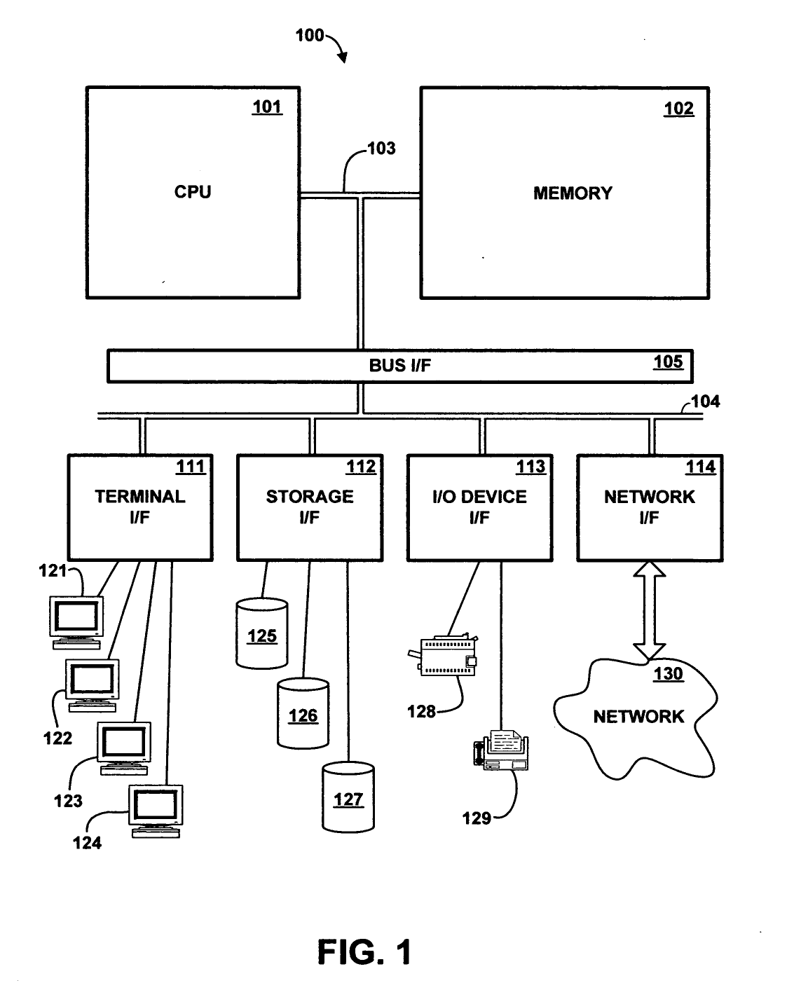

Referring to the Drawing, wherein like numbers denote like parts throughout the several views, FIG. 1 is a high-level representation of the major hardware components of a computer system 100 for determining query execution strategies by predicting the number of records responsive to a condition in a query using respective cardinalities associated with different quantiles of an equal height histogram, according to the preferred embodiment of the present invention. CPU 101 is a general-purpose programmable processor which executes instructions and processes data from main memory 102. Main memory 102 is preferably a random access memory using any of various memory technologies, in which data is loaded from storage or otherwise for processing by CPU 101.

Memory bus 103 provides a data communication path for transferring data among CPU 101, main memory 102 and I/O bus interface unit 105. I/O bus interface 105 is further coupled to system I/O bus 104 for transferring data to and from various I/O units. I/O bus interface 105 communicates with multiple I/O interface units 111-114, which may also be known as I/O processors (IOPs) or I/O adapters (IOAs), through system I/O bus 104. System I/O bus may be, e.g., an industry standard PCI bus, or any other appropriate bus technology. The I/O interface units support communication with a variety of storage and I/O devices. For example, terminal interface unit 111 supports the attachment of one or more user terminals 121-124. Storage interface unit 112 supports the attachment of one or more direct access storage devices (DASD) 125-127 (which are typically rotating magnetic disk drive storage devices, although they could alternatively be other devices, including arrays of disk drives configured to appear as a single large storage device to a host). I/O device interface unit 113 supports the attachment of any of various other types of I/O devices, such as printer 128 and fax machine 129, it being understood that other or additional types of I/O devices could be used. Network interface 114 supports a connection to an external network 130 for communication with one or more other digital devices. Network 130 may be any of various local or wide area networks known in the art. For example, network 130 may be an Ethernet local area network, or it may be the Internet. Additionally, network interface 114 might support connection to multiple networks.

It should be understood that FIG. 1 is intended to depict the representative major components of system 100 at a high level, that individual components may have greater complexity than represented in FIG. 1, that components other than or in addition to those shown in FIG. 1 may be present, and that the number, type and configuration of such components may vary, and that a large computer system will typically have more components than represented in FIG. 1. Several particular examples of such additional complexity or additional variations are disclosed herein, it being understood that these are by way of example only and are not necessarily the only such variations.

Although only a single CPU 101 is shown for illustrative purposes in FIG. 1, computer system 100 may contain multiple CPUs, as is known in the art. Although main memory 102 is shown in FIG. 1 as a single monolithic entity, memory 102 may in fact be distributed and/or hierarchical, as is known in the art. E.g., memory may exist in multiple levels of caches, and these caches may be further divided by function, so that one cache holds instructions while another holds non-instruction data which is used by the processor or processors. Memory may further be distributed and associated with different CPUs or sets of CPUs, as is known in any of various so-called non-uniform memory access (NUMA) computer architectures. Although memory bus 103 is shown in FIG. 1 as a relatively simple, single bus structure providing a direct communication path among CPU 101, main memory 102 and I/O bus interface 105, in fact memory bus 103 may comprise multiple different buses or communication paths, which may be arranged in any of various forms, such as point-to-point links in hierarchical, star or web configurations, multiple hierarchical buses, parallel and redundant paths, etc. Furthermore, while I/O bus interface 105 and I/O bus 104 are shown as single respective units, system 100 may in fact contain multiple I/O bus interface units 105 and/or multiple I/O buses 104. While multiple I/O interface units are shown which separate a system I/O bus 104 from various communications paths running to the various I/O devices, it would alternatively be possible to connect some or all of the I/O devices directly to one or more system I/O buses.

Computer system 100 depicted in FIG. 1 has multiple attached terminals 121-124, such as might be typical of a multi-user “mainframe” computer system. Typically, in such a case the actual number of attached devices is greater than those shown in FIG. 1, although the present invention is not limited to systems of any particular size. User workstations or terminals which access computer system 100 might also be attached to and communicate with system 100 over network 130. Computer system 100 may alternatively be a single-user system, typically containing only a single user display and keyboard input. Furthermore, while the invention herein is described for illustrative purposes as embodied in a single computer system, the present invention could alternatively be implemented using a distributed network of computer systems in communication with one another, in which different functions or steps described herein are performed on different computer systems.

While various system components have been described and shown at a high level, it should be understood that a typical computer system contains many other components not shown, which are not essential to an understanding of the present invention. In the preferred embodiment, computer system 100 is a computer system based on the IBM AS/400™ or i/Series™ architecture, it being understood that the present invention could be implemented on other computer systems.

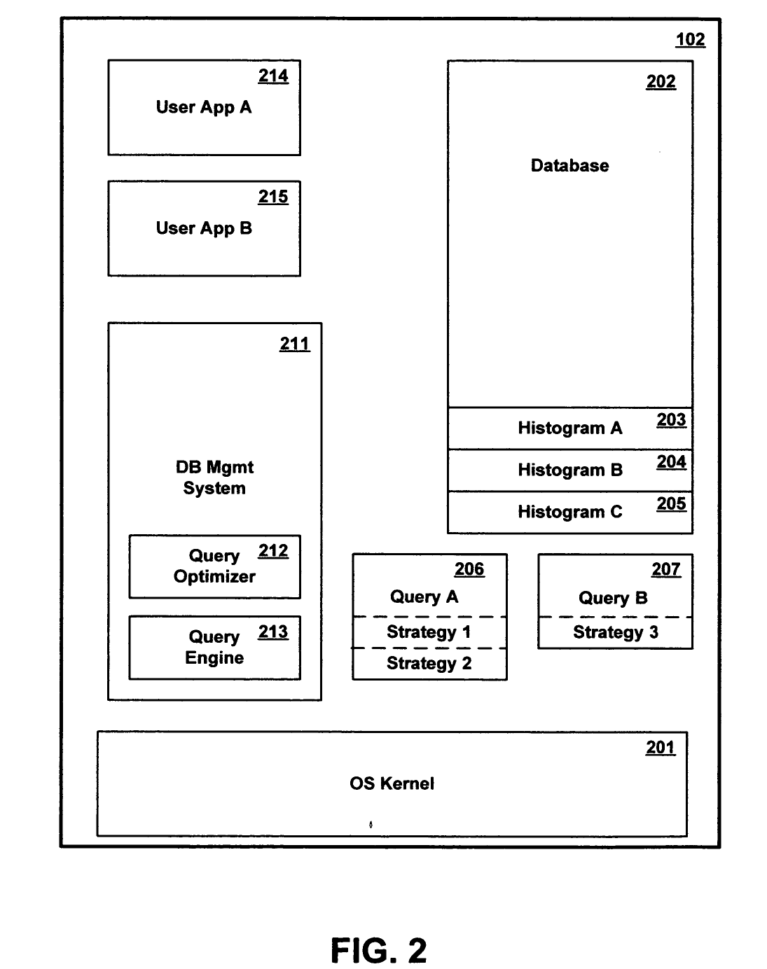

FIG. 2 is a conceptual illustration of the major software components of system 100 in memory 102. Operating system 201 provides various low-level software functions, such as device interfaces, management of memory pages, management and dispatching of multiple tasks, etc. as is well-known in the art. A structured database 202 contains data which is maintained by computer system 100 and for which the system provides access to one or more users, who may be directly attached to system 100 or may be remote clients who access system 100 through a network using a client/server access protocol. Database 202 contains one or more tables, each having a plurality of records, each record containing at least one (and usually many) fields, as is well known in the art. Database 202 might contain almost any type of data which is provided to users by a computer system. Associated with database 202 are multiple equal height histogram data structures 203-205, each histogram representing an allocation of ordered of records in database 202 according to some criterion. Database 202 might also contain one or more sorted indexes (not shown). Although only one database 202 and three histograms 203-205 are shown in FIG. 2, the computer system may contain multiple databases, and the number of histograms may vary (and typically is much larger). Alternatively, database 202 on system 100 may be logically part of a larger distributed database which is stored on multiple computer systems.

Database management system 211 provides basic functions for the management of database 202. Database management system 211 may theoretically support an arbitrary number of databases, although only one is shown in FIG. 2. Database management system 211 preferably allows users to perform basic database operations, such as defining a database, altering the definition of the database, creating, editing and removing records in the database, viewing records in the database, defining database indexes, and so forth. Among the functions supported by database management system 211 is the making of queries against data in database 202. Query support functions in database management system 211 include query optimizer 212 and query engine 213. Database management system 211 may further contain any of various more advanced database functions. Although database management system 211 is represented in FIG. 2 as an entity separate from operating system kernel 201, it will be understood that in some computer architectures various database management functions are integrated with the operating system.

Query optimizer 212 generates query execution strategies for performing database queries. As is known in the database art, the amount of time or resource required to perform a complex query on a large database can vary greatly, depending on various factors, such as the availability of an index, the amount of resources required to evaluate each condition, and the expected selectivity (i.e., number of records eliminated from consideration) of the various logical conditions. Optimizer 212 determines an optimal execution strategy according to any optimizing algorithm, now known or hereafter developed, and generates an execution strategy, also known as an “access plan”, according to the determination. The execution strategy is a defined series of steps for performing the query, and thus is, in effect, a computer program. The optimizer 212 which generates the execution strategy performs a function analogous to that of a compiler, although the execution strategy data is not necessarily executable-level code. It is, rather, a higher-level series of statements which are interpreted and executed by query engine 213.

A query can be saved as a persistent storage object in memory, and can be written to disk or other storage. Once created by optimizer 212, a query execution strategy can be saved with the query as part of the persistent storage object. For a given query, it is possible to generate and save one or multiple optimized execution strategies. The query can be invoked, and a saved query strategy re-used (re-executed), many times.

FIG. 2 represents persistent storage objects Query A 206 and Query B 207. Although two query objects are represented for illustrative purposes in FIG. 2, it will be understood that the actual number of such entities may vary, that typically a large computer system contains a much larger number of query objects. Furthermore, each query object may contain or be associated with zero, one, two, or more than two execution strategies (as shown, Query A 206 contains two execution strategies), multiple alternative strategies being useful in situations where the query imports values into one or more conditions, making the number of records selected by the condition variable. Although these are referred to herein as “query objects”, the use of the term “object” is not meant to imply that database management system 211 or other components are necessarily programmed using so-called object-oriented programming techniques, or that the query object necessarily has the attributes of an object in an object-oriented programming environment, although it would be possible to implement them using object-oriented programming constructs.

In addition to database management system 211, one or more user applications 214, 215 executing on CPU 101 may access data in database 202 to perform tasks on behalf of one or more users. Such user applications may include, e.g., personnel records, accounting, code development and compilation, mail, calendaring, or any of thousands of user applications. Some of these applications may access database data in a read-only manner, while others have the ability to update data. There may be many different types of read or write database access tasks, each accessing different data or requesting different operations on the data. For example, one task may access data from a specific, known record, and optionally update it, while another task may invoke a query, in which all records in the database are matched to some specified search criteria, data from the matched records being returned, and optionally updated. Furthermore, data may be read from or written to database 202 directly, or may require manipulation or combination with other data supplied by a user, obtained from another database, or some other source. Although two applications 214, 215 are shown for illustrative purposes in FIG. 2, the number of such applications may vary. Applications 214, 215 typically utilize function calls to database manager 211 to access data in database 202, and in particular, to execute queries to data in the database, although in some systems it may be possible to independently access data in database 202 directly from the application.

Various software entities are represented in FIG. 2 as being separate entities or contained within other entities. However, it will be understood that this representation is for illustrative purposes only, and that particular modules or data entities could be separate entities, or part of a common module or package of modules. Furthermore, although a certain number and type of software entities are shown in the conceptual representation of FIG. 2, it will be understood that the actual number of such entities may vary, and in particular, that in a complex database server environment, the number and complexity of such entities is typically much larger. Additionally, although software components 202-207 and 211-215 are depicted in FIG. 2 on a single computer system 100 for completeness of the representation, it is not necessarily true that all programs, functions and data will be present on a single computer system or will be performed on a single computer system. For example, user applications may be on a separate system from the database; a database may be distributed among multiple computer systems, so that queries against the database are transmitted to remote systems for resolution, and so forth.

While the software components of FIG. 2 are shown conceptually as residing in memory 102, it will be understood that in general the memory of a computer system will be too small to hold all programs and data simultaneously, and that information is typically stored in data storage devices 125-127, comprising one or more mass storage devices such as rotating magnetic disk drives, and that the information is paged into memory by the operating system as required. In particular, database 202 is typically much too large to be loaded into memory, and typically only a small portion of the total number of database records is loaded into memory at any one time. The full database 202 is typically recorded in disk storage 125-127. Furthermore, it will be understood that the conceptual representation of FIG. 2 is not meant to imply any particular memory organizational model, that system 100 might employ a single address space virtual memory, or might employ multiple virtual address spaces which overlap.

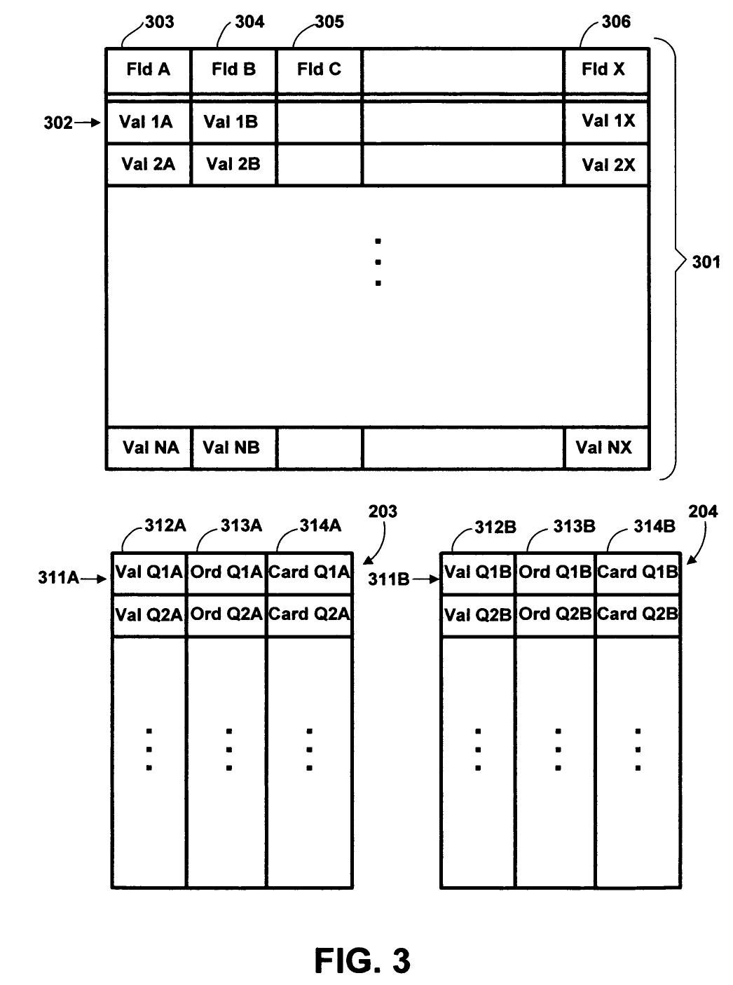

FIG. 3 is a conceptual representation of the structure of database 202 and equal-height histogram data structures 203 associated with tables in database 202, according to the preferred embodiment. Database 202 comprises one or more database tables 301 (of which only one is shown in FIG. 3). Each table contains multiple database records 302, each record containing multiple data values logically organized as multiple data fields 303-306. Database 202 is conceptually represented in FIG. 3 as a table or array, in which the rows represent database records, and the columns represent data fields. However, as is well known in the art, the actual structure of the database in memory typically varies due to the needs of memory organization, accommodating database updates, and so forth. A database will often occupy non-contiguous blocks of memory; database records and individual fields within database records may vary in length; some fields might be present in only a subset of the database records; and individual records may be non-contiguous. Portions of the data may even be present on other computer systems. Various pointers, arrays, and other structures (not shown) may be required to identify the locations of different data contained in the database.

Because database 202 may contain a very large number of records, and it is frequently necessary to estimate, for query execution or other purposes, the number of records corresponding to some logical criterion, database histograms 203-205 are maintained to provide an abbreviated view of the distribution of records according to a logical criterion. An “equal height histogram” allocates records among multiple discrete “quantiles”, according to the value of an ordered database field which controls the histogram, a different controlling database field being used for each respective histogram. FIG. 3 represents two histograms 203, 204, where histogram 203 is controlled by field A 303, and histogram 204 is controlled by field B 304.

Conceptually, each equal-height histogram data structure contains multiple entries 311A, 311B (herein generically referred to as feature 311), each histogram entry 311 identifying the boundary of a respective quantile. I.e., in histogram 204 controlled by field A 303, if one assumes a theoretical ordering of the entries 302 in database table according to the values of field 303 in each entry, then each histogram entry 311 identifies the boundary of the quantile by identifying the value of the controlling field corresponds to a respective entry 302 in a database table 301 which marks the boundary of a quantile. Similarly, in histogram 205 controlled by field B 304, each histogram entry 311 identifies the boundary of a quantile in an ordering of records by field 304. By convention, this entry could either be the first entry in a quantile or the last; in the discussion herein, it is assumed to be the first. Ideally, the number of entries in each quantile is the same, hence the term “equal-height histogram”. However, strict equality is not necessary, and in a typical database the histogram is designed and maintained to achieve approximate equality of distribution.

Each histogram entry 311 contains a value 312A, 312B (herein generically referred to as feature 312), an ordinal number 313A, 313B (herein generically referred to as feature 313, and a cardinality 314A, 314B (herein generically referred to as feature 314). The value 313 is the value from the controlling field allocated by the histogram for a corresponding database entry at the boundary of the quantile. E.g., for histogram data structure 203, which allocates database records into quantiles according to the value of field A 303 (the controlling field), the value 312 is the value of field A 303 at the boundary of a quantile (which could be either the first or last value in the quantile, according to a pre-established convention). The ordinal number is a relative representation of the number of database records, in a theoretical ordering of records according to the controlling field, which precede (or precede and include, depending on whether the entry corresponds to the first or last value in the quantile) the record(s) containing the value in value field 312 of the same entry 311. I.e., if the histogram entry contains the first value in each quantile, ordinal number field 313 represents the cumulative number of entries allocated to each previous quantile. The cardinality 314 is a relative representation of the number of different discrete values of the controlling field within the quantile. In the preferred embodiment, both the ordinal number and the cardinality are obtained by sampling techniques as herein described, and are not exact counts of the quantities they are intended to represent, nor are they approximations. They represent relative quantile sizes and relative degree of cardinality among the various quantiles. However, in alternative embodiments, such numbers could be actual exact counts or approximations produced using any of various techniques.

Although the histogram data structures 203, 204 are represented conceptually in FIG. 3 as tables or arrays, a different structure, such as a binary tree, may be used due to the need to quickly identify the location of a desired value in a sorted order.

Among the functions supported by database management system 211 is the making of queries against data in database 202, which are executed by query engine 213. As is known, queries typically take the form of statements having a defined format, which test records in the database to find matches to some set of logical conditions. Typically, multiple terms, each expressing a logical condition, are connected by logical conjunctives such as “AND” and “OR”. Because database 202 may be very large, having a very large number of records, and a query may be quite complex, involving multiple logical conditions, it can take some time for a query to be executed against the database, i.e., for all the necessary records to be reviewed and to determine which records, if any, match the conditions of the query.

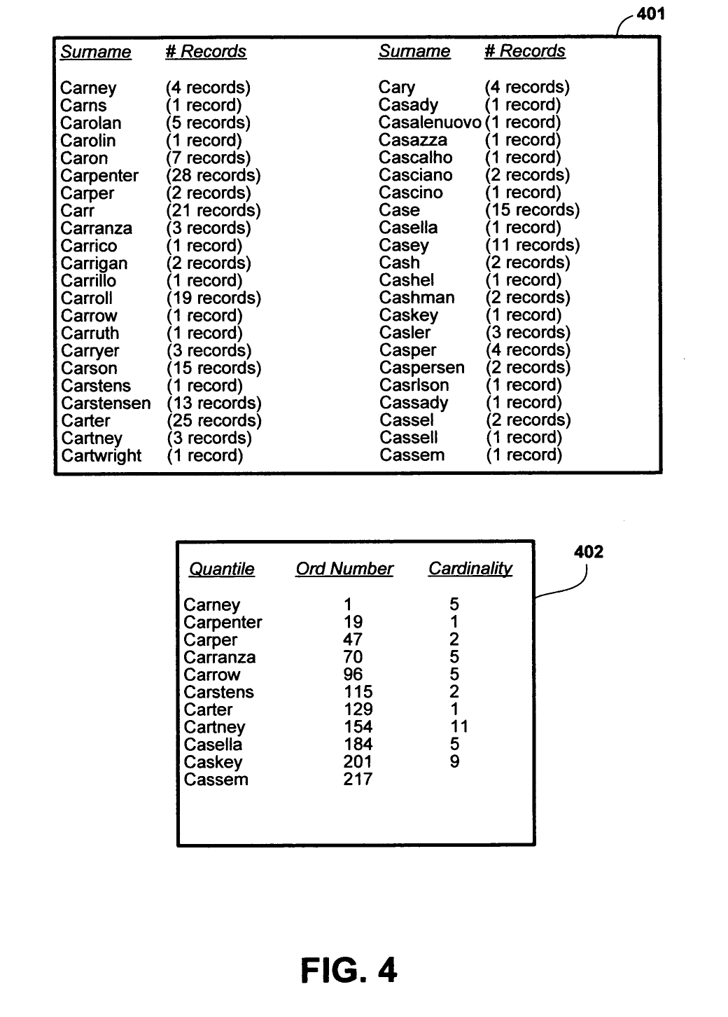

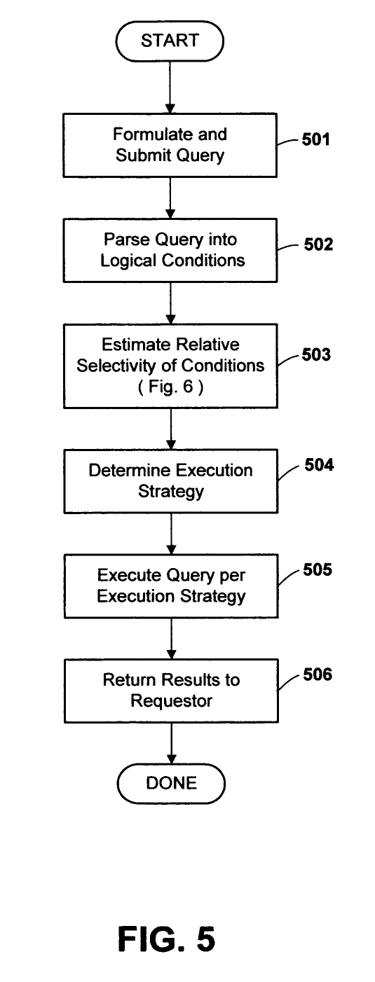

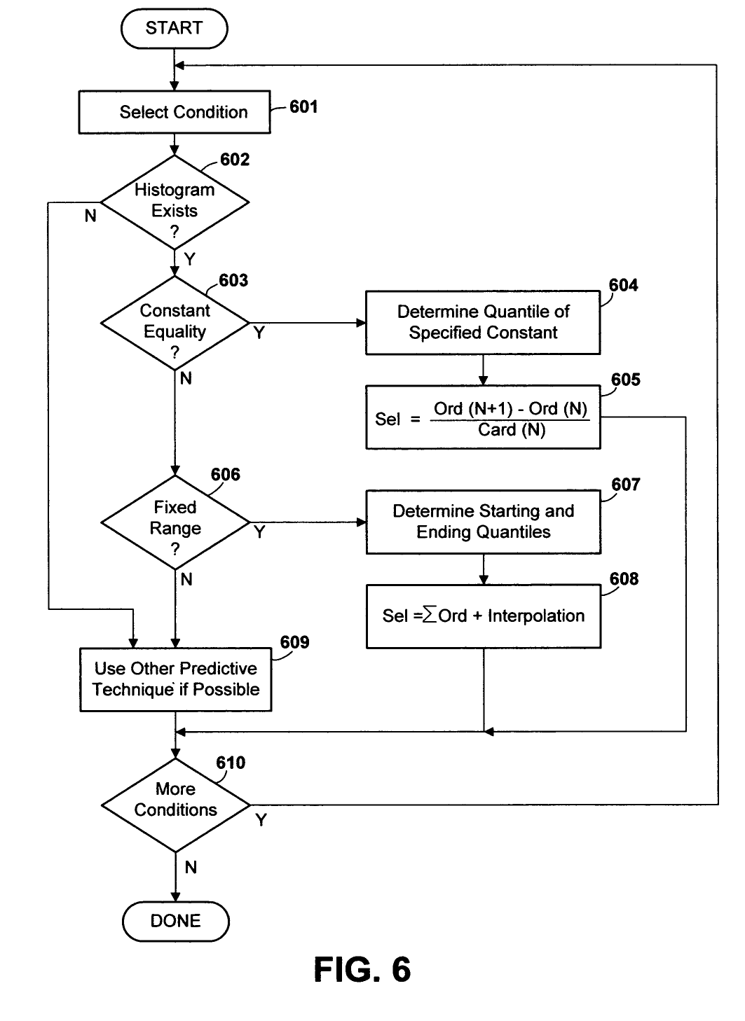

The amount of time required to perform a complex query on a large database can vary greatly, depending on many factors, such as the order of evaluation, whether indexing is used, and so forth. In order to determine of the best execution strategy from among multiple potential alternatives, the system should be able to accurately predict the selectivity of the various conditions of the query. In accordance with the preferred embodiment of the present invention, if the condition specifies equality with a particular discrete value of a database field which is a controlling field of a corresponding equal-height histogram, selectivity is predicted or estimated as the number of records in the quantile in which the particular discrete value falls divided by the cardinality of the quantile. Furthermore, if a condition specifies a range of values ending within a quantile, the cardinality of the quantile is used to predict the number of records within the quantile that are also within the range of the condition. The application of this technique is illustrated by the simplified example data of FIG. 4. Furthermore, FIGS. 5 and 6 are flow diagrams illustrating the process of executing a database query, according to the preferred embodiment.

Referring to FIG. 4, a simplified portion of a database table includes multiple record entries, each entry having a field “surname”. Because surnames are not unique, some records contain the same surname as other records. However, as is well known, the distribution of surnames is far from even. Some surnames in the database are indeed unique and occur only once, while other surnames occur many times.

A portion of the table represented as feature 401 illustrates a sorting of surnames in alphabetical order, and the number of records associated with each surname. In the example of FIG. 4, 44 different surnames appear in a table portion having 217 different records. Therefore, on the average, there are nearly 5 records for each surname. But many surnames occur only once, while others occur well in excess of 5 times.

An equal height histogram record 402 corresponds to table 401. The equal height histogram allocates the entries in the table into 10 quantiles, which are not precisely equal. The entries in histogram record 402 correspond to the boundaries of the quantiles. Thus, the first quantile begins with the ordered value “Carney”, the second quantile with the ordered value “Carpenter”, and so on. The final entry in the histogram record simply records the last value (“Cassem”) in the table. The ordinal number field within each entry of the histogram record contains the ordinal position of the corresponding controlling field (“surname” field) value in an ordered list of surnames. Thus, the value “Carney” occurs at ordered position number 1, the value “Carpenter” at ordered position number 19, and so on. By subtracting adjacent ordinal number values, one can readily determine the number of records in each respective quantile. E.g., the number of records in the first quantile is the ordinal position of “Carpenter” (marking the beginning of the second quantile) minus the ordinal position of “Carney” (marking the beginning of the first quantile, i.e., 19−1=18. The cardinality refers to the number of different controlling field values in the corresponding quantile. The first quantile contains a cardinality of 5, i.e., there are five discrete values (“Carney”, “Carns”, “Carolan”, “Carolin” and “Caron”) in the first quantile. By convention, quantiles are generally allocated so that a single controlling field value does not cross a quantile boundary; as a result, the allocation of records to quantiles is not always an equal distribution.

If a query contains a condition of the form Surname=Surname Value, it is desirable to estimate the selectivity of the condition, i.e., the number of records for which the condition is true. Using prior art techniques, the only information available is typically the number of records and total cardinality of the database. I.e., from the fact that there are 217 records and 44 discrete values, we may estimate that the condition will select about 5 records. However, if the value specified is “Carpenter” or some other frequently occurring name, this estimate is rather poor.

In accordance with the preferred embodiment, the number in the applicable quantile is divided by the cardinality of the quantile to form an estimate. Thus, if the value of the controlling field specified is “Carpenter”, the system determines that this value lies in the second quantile, that there are 28 records in the second quantile, and that the second quantile has a cardinality of 1. Dividing 28 by 1 yields 28, which is exactly the correct number. If the value specified is “Casciano”, the system determines that this value lies in the eighth quantile, that the quantile contains 30 records and has a cardinality of 11. The estimated number of responsive records is 3, which is closer to the actual number (2) than prior art techniques. The cardinality can similarly be used to improve the predicted value where a range of records is specified, particularly if the cardinality of a quantile is small. For example, if a condition specifies records having value less than or equal to “Carr”, the fact that the “Carr” lies in the third quantile, having a cardinality of 2, enables the inference (correct) that all of the third quantile should be included in the range. Using prior art techniques, it is impossible to determine which part of the third quantile should be included in the range, and it is common to simply include a fixed percentage, such as ⅓.

Of course, the predictive technique of the present invention does not always produce a better prediction that prior art techniques. For example, if the value “Carper” is specified, the system determines that it lies in the third quantile, with a size of 23 and cardinality of 2. The system would therefore predict approximately 12 responsive records, when in fact there are only 2 records with a value of “Carper”. But in general, the predictive technique of the present invention will be more accurate than the prior art technique of assuming a uniform distribution over the entire database.

It will be understood that the example database portion of FIG. 4 is greatly simplified for illustrative purposes, and that an actual database would typically have a much larger number of entries. Furthermore, due to the practicalities of maintaining histogram data in a large database in which the data is subject to frequent revision, the histogram data of the preferred embodiment is obtained by sampling techniques which produce relative representations of ordinal number and cardinality, rather than exact counts.

Referring to FIG. 5, a high-level view of a process of executing a database query utilizing the predictive technique herein is illustrated. A requesting user formulates and submits a database query using any of various techniques now known or hereafter developed (step 501). E.g., the database query might be constructed and submitted interactively using a query interface in database management system 211, might be submitted from a separate interactive query application program, or might be embedded in a user application and submitted by a call to the query engine 212 when the user application is executed. A query might be submitted from an application executing on system 100, or might be submitted from a remote application executing on a different computer system. In response to receiving the query, query engine 212 parses the query into logical conditions to generate a query object (step 502), which may be saved for re-use. As an alternative to formulating, saving and parsing a new query, a user might select a previously parsed and saved query for re-submission.

The database management system invokes optimizer 212 to generate an optimized execution strategy for the query. In order to determine an optimized execution strategy, an estimate of the number of the selectivity of each condition of the query is generated, either by the optimizer or some other facility in the database management system. Estimating the selectivity of the conditions is depicted in FIG. 5 as step 503, and shown in greater detail in FIG. 6.

Referring to FIG. 6, the system estimates the selectivity of various query conditions by selecting each condition in turn (step 601). If the selected condition specifies a field value controlling a histogram record, the ‘Y’ branch is taken from step 602. In this case, the condition is typically an equality or a range. I.e., the condition typically specifies that the value of the controlling field variable be equal to some discrete constant value, or that the value of the controlling field variable lie within some specified constant range of values. If an equality is specified, the ‘Y’ branch is taken from step 603. The system then accesses the histogram record controlled by the controlling field, and determines the quantile in which the specified discrete value lies (step 604). The selectivity (relative number of records meeting the specified condition) is then estimated by subtracting the ordinal number of the quantile in which the specified value lies from the ordinal number of the succeeding quantile (to obtain a relative measure of the number of records in the quantile in which the specified discrete value lies), and dividing the difference by the cardinality of the quantile in which the specified discrete value lies (step 605). In the preferred embodiment, the ordinal number stored in the histogram is the number obtained by counting a small sample, as described below herein. The selectivity obtained as described above can be normalized, e.g. by dividing by the sample size (to obtain selectivity as a fraction of the total database table) or multiplying by the ratio of total database size to sample size (to obtain selectivity as a predicted number of records in the total database table). The system then proceeds to step 611.

If the selected condition does not specify a discrete value of the controlling field variable (the ‘N’ branch from step 603), and specifies a range for a field value controlling a histogram (the ‘Y’ branch from step 606), the system determines the starting and ending quantiles covered by the range (step 607). The selectivity is then estimated as the summation of the sizes of the quantiles covered by the range (step 608). Since the ordinal numbers in the histogram data are cumulative representations, it is not necessary to actually add the individual quantiles, but it merely necessary to take the difference between the beginning of the first full quantile and end of the last full quantile within the range. For any final quantile or quantiles only partially within the range, any of various interpolations may be used and added to the summation of full quantiles within the range, as described below. This selectivity can be normalized as described above with respect to step 605.

In a prior art technique a fixed fraction (e.g., ⅓) of the final (partial) quantile is used as an interpolation. It would be possible to follow this practice, but in the preferred embodiment, the cardinality of the final partial quantile is used to provide an interpolation. Specifically, rather than assume that ⅓ of the records falls within the desired range, it is assumed that approximately ⅓ of the unknown discrete values fall within that range. I.e, for a ‘<’ or ‘≦’ condition, where the value specified in the condition is not a boundary value of a quantile listed in the histogram record (the boundary value being treated as a special case), the number of discrete values less than the value specified in the condition is assumed to be:
1+INT[(Card−2)/3]
where Card is the cardinality of the final (partial) quantile), and INT is the integer (rounding down) function. For ‘>’ or ‘≧’ conditions, the number of discrete values greater than the value specified in the condition is assumed to be:
INT[(Card−2)/3]
The number of discrete values in the range specified by the condition as derived above is then incremented by one for an inclusive (≦ or ≧) condition. This number of discrete values is divided by the cardinality to obtain the fraction of records in the final partial quantile which are within the range of the condition. Where the cardinality is large, these assumptions produce results which are approximately the same as using a fixed ⅓ fraction. But where the cardinality is small, a significantly different, and generally better, estimate is produced. E.g., in the example of FIG. 4, if a condition specifies “≦Carr”, the value “Carr” is determined to be in the third quantile, having a cardinality of 2; the number of discrete values preceding “Carr” is 1, which is incremented by 1 to get the number of discrete values in the range of the condition, and divided by the cardinality to yield 2/2=100% as the fraction of records in the final quantile which are included in the range. This fraction turns out to be correct. As is known in the art, various techniques could be used to simplify the calculations.

In the special case where a condition specifies a range for a field value controlling a histogram, and the value defining the range is a boundary value of a quantile, either none of the quantile is included in the range (the “<SpecifiedValue” condition), or the quantile size divided by the cardinality is included in the range (the “≦” condition), or the quantile size minus the quantile size divided by the cardinality (“>” condition) is included in the range, or the entire quantile (the “≧” condition) is included in the range.

If the selected conditions does not specify a field value controlling a histogram (the ‘N’ branch from step 602) or if the selected condition specifies a field value, but it is neither a discrete value nor a range of values, then the system may use other techniques, if possible, to estimate the selectivity of the condition, represented in FIG. 6 as step 609. In fact, in many if not most such instances, in may be difficult or impossible to estimate the selectivity of the condition at step 609, and the system will have to make arbitrary assumptions regarding selectivity. For example, a condition may a relationship between two field values, or between a field value and some user defined function, for which no readily available means of estimating the selectivity exists.

If more conditions remain to be evaluated for selectivity, the ‘Y’ branch is taken from step 610, and the system returns to step 601 to select the next condition. When all conditions have been considered and selectivity estimated, the ‘N’ branch is taken from step 610.

Referring again to FIG. 5, the system then determines a suitable execution strategy for the query (step 504), using the predicted selectivity of the different query conditions generated previously using the process of FIG. 6. This could involve invoking the query optimizer to generate a new execution strategy for the query. For a previously saved query, it could alternatively mean selecting a previously generated query strategy, possibly from among multiple previously generated and saved query strategies. The system may determine a suitable execution strategy in accordance with any of various techniques, now known or hereafter developed, which use a prediction or estimation of the relative selectivity of various conditions within the query to determine an optimal strategy.

After determining a suitable execution strategy, the query engine executes the query in accordance with the strategy previously determined (step 505). The query engine then generates and returns results in an appropriate form (step 506). E.g., where a user issues an interactive query, this typically means returning a list of matching database entries for display to the user. A query from an application program may perform some other function with respect to database entries matching a query.

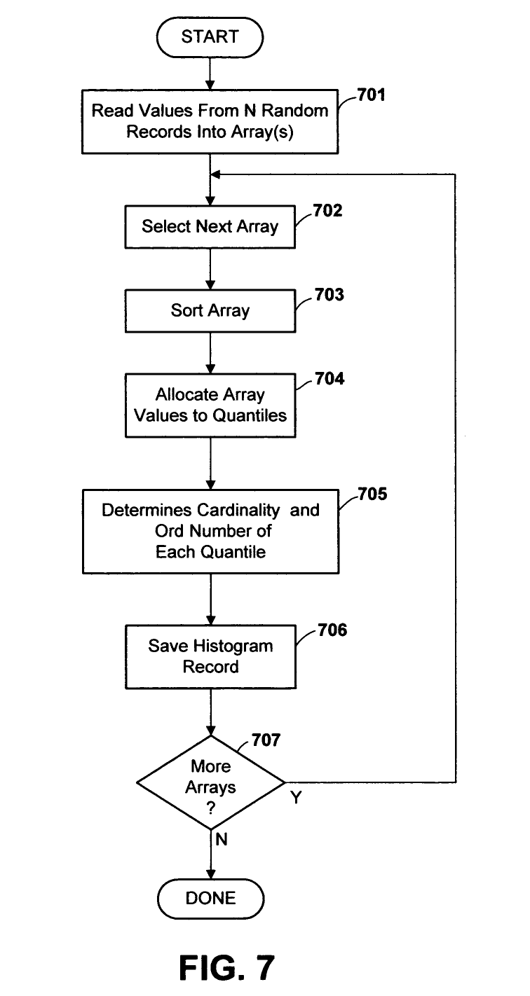

As explained previously, in the preferred embodiment, the values in the histogram records are not exact values, but are representative values derived by sampling the database. As is well known, most large databases are subject to frequent revision, making it generally impossible to obtain precise histogram data without enormous overhead burden. FIG. 7 is a high-level flow diagram representing a process for generating sampled histogram records, according to the preferred embodiment.

Histogram records are preferably regenerated on a periodic basis, when there is reason to believe that existing histogram data has become stale. A process for re-generating histogram records can be triggered by any of various events. For example, it might be triggered by the mere passage of time, or after some predetermined number of database alterations have been made, or based on some other criteria.

When the histogram regeneration process is triggered, the system accesses and reads the controlling field values of a random sample of records (step 701). For a typical large database table, 2000 records are chosen as a random sample, it being understood that this number could vary. A separate array of 2000 values is allocated for each database field controlling a respective histogram. From each record read, the values of the controlling database field are entered into the respective array corresponding to the field. Preferably, the random sample of records is accessed and read as part of a larger process of characterizing the database, which obtains estimates of the total number of discrete values in the database as well as other useful information.

When the array or arrays have been populated, the system selects an array for processing (step 702). The values in the array are then sorted in order of the ordering relation corresponding to the controlling database field from which the values were derived (step 703). E.g., text values might be sorted in alphabetical order; numbers are typically sorted in ascending numerical order, etc. It is possible that some values will appear multiple times in the array.

After sorting the values in order, the values are allocated to quantiles (step 704). In the preferred embodiment, the array of 2000 values is allocated to up to 100 quantiles, it being understood that the number may vary. Therefore, each quantile ideally has 20 values, although it is not always possible to obtain a precisely equal distribution because multiple occurrences of a single value should be placed in the same quantile.

The system then determines the ordinal number and cardinality corresponding to each quantile (step 705). The ordinal number is the number of array values in the previous quantiles plus one. The cardinality is the number of different discrete array values in the quantile. The system them builds a new histogram record using the quantile boundary values, ordinal numbers and cardinalities thus determined (step 706).

If any more arrays remain to be processed, the ‘Y’ branch is taken from step 707, and a new array is selected at step 702. When all arrays have been processed and corresponding histogram records constructed, the ‘N’ branch is taken from step 707 and the process completes.

It will be observed that the ordinal number and cardinalities thus derived are neither exact counts nor estimates of the actual cumulative number of records at the quantile boundaries or number of discrete values within the quantiles in the database table. If desired, a true cumulative number could be estimated by scaling the ordinal numbers derived in step 705. For example, if it is known that the database table contains two million records, and the array contains 2000 values, one could scale the ordinal numbers by 1000 to obtain an approximation of the actual quantile sizes. However, the cardinalities are not necessarily scalable. In the same circumstance, if a quantile having 20 values has a cardinality of 20, i.e., all the values are different, if is difficult to say whether the actual number of different values within the quantile in the database table is on the order of 20,000 (i.e., all values are different), or on the order of 200. Therefore, the cardinality is useful primarily as a relative measure. I.e., if one quantile has a cardinality of 2 and a second quantile a cardinality of 20, it is likely that the number of discrete values in the second quantile is larger than the number of such values in the first, although it would be difficult to say just how many such values there are. If it is desirable or necessary to estimate true cardinalities, one could apportion the estimated total cardinality of the database using the proportions indicated by the cardinality values derived as explained above.

Among the advantages of the technique described herein as a preferred embodiment is the relatively low overhead of implementation. Conventional large database management systems typically collect histogram data periodically. In order to collect histogram data, the data gathering steps of FIG. 7 are performed already. I.e., a random sample of database records is read, values derived are sorted and allocated to quantiles. In accordance with the preferred embodiment, the only additional steps required are the derivation and saving of respective cardinalities for each of the quantiles. The additional processing work required for this implementation is almost negligible in comparison to the existing overhead of collecting and maintaining histogram data.

Although a particular technique for generating histogram values representing cardinality and ordinal number is described herein, many alternative approximation techniques are possible, and the cardinality and ordinal numbers produced by any alternative technique might be actual counts, estimates of actual counts, or, as in the preferred embodiment, values which are relative representations without being actual counts or estimates of actual counts.

In the preferred embodiment, a relative measure of selectivity of query conditions is obtained by dividing a quantile size measure (derived from the ordinal number) by the cardinality of the quantile. However, if all quantiles are the same size, it is unnecessary to use the quantile size measure, and a relative selectivity may be obtained solely from the cardinality. Although quantiles are not generally identical in size, it would, in an alternative embodiment, be possible to assume for purposes of approximation that all quantiles are the same size, and thus simplify the computation required. Furthermore, if it is only necessary to make a comparison among multiple conditions specifying equality of a database field to a respective fixed value, the division may be dispensed with and cardinality values compared directly. I.e., if it is only necessary to determine which condition of multiple conditions has greatest selectivity, it may be assumed that the condition having the highest corresponding cardinality value has the greatest selectivity. These or any of various other computational simplifications or approximations may be used in alternative embodiments.

In the preferred embodiment described above, the generation and execution of the query is described as a series of steps in a particular order. However, it will be recognized by those skilled in the art that the order of performing certain steps may vary, and that variations in addition to those specifically mentioned above exist in the way particular steps might be performed. In particular, the manner in which queries are written, parsed or compiled, and stored, may vary depending on the database environment and other factors. Furthermore, it may be possible to present the user with intermediate results during the evaluation phase.

In general, the routines executed to implement the illustrated embodiments of the invention, whether implemented as part of an operating system or a specific application, program, object, module or sequence of instructions, are referred to herein as “programs” or “computer programs”. The programs typically comprise instructions which, when read and executed by one or more processors in the devices or systems in a computer system consistent with the invention, cause those devices or systems to perform the steps necessary to execute steps or generate elements embodying the various aspects of the present invention. Moreover, while the invention has and hereinafter will be described in the context of fully functioning computer systems, the various embodiments of the invention are capable of being distributed as a program product in a variety of forms, and the invention applies equally regardless of the particular type of signal-bearing media used to actually carry out the distribution. Examples of signal-bearing media include, but are not limited to, recordable type media such as volatile and non-volatile memory devices, floppy disks, hard-disk drives, CD-ROM's, DVD's, magnetic tape, and transmission-type media such as digital and analog communications links, including wireless communications links. An example of signal-bearing media is illustrated in FIG. 1 as system memory 102, and as data storage devices 125-127.

Although a specific embodiment of the invention has been disclosed along with certain alternatives, it will be recognized by those skilled in the art that additional variations in form and detail may be made within the scope of the following claims:

What is claimed is:

1. A method for executing a database query in a computer system, comprising the steps of:
automatically associating, for at least one database field, a respective representation of cardinality with each of a plurality of discrete subsets of records in said database;
invoking a database query, said database query containing a plurality of logical conditions;
automatically predicting a relative selectivity of at least some of said plurality of logical conditions using said respective representation of cardinality; and
automatically determining a query execution strategy using said predicted relative selectivity of at least some of said plurality of logical conditions; and
executing said database query according to said query execution strategy determined by said step of automatically determining a query execution strategy.

2. The method for executing a database query of claim 1, wherein each of said plurality of discrete subsets is defined as a quantile of a histogram controlled by a corresponding database field of said at least one database field.

3. The method for executing a database query of claim 2, wherein said histogram associates, with each of said quantiles, a respective representation of quantile size and respective representation of cardinality.

4. The method for executing a database query of claim 1, wherein at least one of said plurality of logical conditions for which relative selectivity is predicted by said step of automatically predicting a relative selectivity comprises a condition requiring that a value of a respective database field of said at least one database field be equal to a respective fixed discrete value.

5. The method for executing a database query of claim 4,
wherein said respective fixed discrete value of a respective database field in a logical condition is associated with a respective discrete subset of records in said database; and
wherein said step of automatically predicting a relative selectivity of at least some of said plurality of logical conditions predicts a relative selectivity of said at least one condition requiring that a value of a respective database field of said at least one database field be equal to a respective fixed discrete value as a function of the reciprocal of the cardinality of the discrete subset with which the respective fixed discrete value of the respective database field is associated.

6. The method for executing a database query of claim 5,
wherein a respective representation of relative size is associated with each said discrete subset of records in said database; and
wherein said step of automatically predicting a relative selectivity of at least some of said plurality of logical conditions predicts a relative selectivity of said at least one condition requiring that a value of a respective database field of said at least one database field be equal to a respective fixed discrete value as a function of the ratio of the representation of relative size to the cardinality of the discrete subset with which the respective fixed discrete value of the respective database field is associated.

7. The method for executing a database query of claim 1, wherein at least one of said plurality of logical conditions for which relative selectivity is predicted by said step of automatically predicting a relative selectivity comprises a condition requiring that a value of a respective database field of said at least one database field be within a respective fixed range of values.

8. The method for executing a database query of claim 1, wherein said step of automatically associating, for at least one database field, a respective representation of cardinality with each of a plurality of discrete subsets of records comprises the steps of:
automatically associating, for each of a plurality of database fields, a respective set containing a plurality of discrete subsets of records in said database; and
automatically associating, for each of said plurality of database fields, a respective representation of cardinality with each of said plurality discrete subsets of records in said database contained in the respective set of discrete subsets associated with the respective database field.

9. The method for executing a database query of claim 1, wherein said step of automatically associating, for at least one database field, a respective representation of cardinality with each of a plurality of discrete subsets of records comprises the steps of:
automatically sampling a plurality of records in said database to obtain a plurality of sampled values for said at least one database field;
automatically allocating said plurality of sampled values to said plurality of discrete subsets; and
automatically determining a respective cardinality of the allocated sampled values in each said discrete subset.

10. A computer program product supporting execution of database queries in a computer system, comprising:
a plurality of computer executable instructions recorded on signal-bearing media, wherein said instructions, when executed by at least one computer system, cause the at least one computer system to perform the steps of:
associating, for at least one database field, a respective representation of cardinality with each of a plurality of discrete subsets of records in said database;
receiving a database query, said database query containing a plurality of logical conditions;
predicting a relative selectivity of at least some of said plurality of logical conditions using said respective representation of cardinality; and
determining a query execution strategy using said predicted relative selectivity of at least some of said plurality of logical conditions; and
executing said database query according to said query execution strategy determined by said step of determining a query execution strategy.

11. The computer program product of claim 10, wherein each of said plurality of discrete subsets is defined as a quantile of a histogram controlled by a corresponding database field of said at least one database field.

12. The computer program product of claim 11, wherein said histogram associates, with each of said quantiles, a respective representation of quantile size and respective representation of cardinality.

13. The computer program product of claim 10, wherein at least one of said plurality of logical conditions for which relative selectivity is predicted by said step of predicting a relative selectivity comprises a condition requiring that a value of a respective database field of said at least one database field be equal to a respective fixed discrete value.

14. The computer program product of claim 13,
wherein said respective fixed discrete value of a respective database field in a logical condition is associated with a respective discrete subset of records in said database; and
wherein said step of predicting a relative selectivity of at least some of said plurality of logical conditions predicts a relative selectivity of said at least one condition requiring that a value of a respective database field of said at least one database field be equal to a respective fixed discrete value as a function of the reciprocal of the cardinality of the discrete subset with which the respective fixed discrete value of the respective database field is associated.

15. The computer program product of claim 14,
wherein a respective representation of relative size is associated with each said discrete subset of records in said database; and
wherein said step of predicting a relative selectivity of at least some of said plurality of logical conditions predicts a relative selectivity of said at least one condition requiring that a value of a respective database field of said at least one database field be equal to a respective fixed discrete value as a function of the ratio of the representation of relative size to the cardinality of the discrete subset with which the respective fixed discrete value of the respective database field is associated.

16. The computer program product of claim 10, wherein at least one of said plurality of logical conditions for which relative selectivity is predicted by said step of predicting a relative selectivity comprises a condition requiring that a value of a respective database field of said at least one database field be within a respective fixed range of values.

17. The computer program product of claim 10, wherein said step of associating, for at least one database field, a respective representation of cardinality with each of a plurality of discrete subsets of records comprises the steps of:
associating, for each of a plurality of database fields, a respective set containing a plurality of discrete subsets of records in said database; and
associating, for each of said plurality of database fields, a respective representation of cardinality with each of said plurality discrete subsets of records in said database contained in the respective set of discrete subsets associated with the respective database field.

18. The computer program product of claim 10, wherein said step of associating, for at least one database field, a respective representation of cardinality with each of a plurality of discrete subsets of records comprises the steps of:
sampling a plurality of records in said database to obtain a plurality of sampled values for said at least one database field;
allocating said plurality of sampled values to said plurality of discrete subsets; and
determining a respective cardinality of the allocated sampled values in each said discrete subset.

19. A computer system, comprising:
at least one processor;
a memory;
a database having a plurality of records;
a plurality of histograms associated with respective database fields of said database, each of said histograms allocating records of said database to a respective set of quantiles in an ordered relation of the respective database field with which the histogram is associated; each histogram containing, for each quantile of the respective set of quantiles, a respective representation of cardinality within the quantile of values of the respective database field with which the histogram is associated and a respective representation of a number of records within the quantile;
a database management facility which executes logical queries against said database, said database management facility automatically executes a logical query by:
(a) determining for each respective logical condition of said at least some logical conditions, a quantile responsive to the logical condition,
(b) predicting a selectivity using a ratio of said representation of a number of records within a quantile responsive to the logical condition to said representation of cardinality of the quantile responsive to the logical condition,
(c) determining a query execution strategy using said predicted relative selectivity of at least some of said plurality of logical conditions, and
(d) executing the database query according to said query execution strategy determined using said predicted relative selectivity.

20. The computer system of claim 19, wherein said database management system maintains said plurality of histograms by:
periodically sampling a plurality of records in said database to obtain a plurality of sampled values for each of said histograms from each of a respective associated database field;
for each histogram, allocating said plurality of sampled values to a plurality of quantiles; and
determining a respective cardinality and number of sampled values in each said quantile.
